(19) United States
(12) Patent Application Publication
(10) Pub. No.: US 2015/0006679 A1
(43) Pub. Date: Jan. 1, 2015

(54) INDIVIDUAL INFORMATION MANAGEMENT SYSTEM, ELECTRONIC DEVICE, AND METHOD FOR MANAGING INDIVIDUAL INFORMATION

(71) Applicant: Kabushiki Kaisha Toshiba, Tokyo (JP)

(72) Inventor: Eita Shuto, Suginami-ku (JP)

(73) Assignee: Kabushiki Kaisha Toshiba, Tokyo (JP)

(21) Appl. No.: 14/243,519

(22) Filed: Apr. 2, 2014

(30) Foreign Application Priority Data
Jun. 27, 2013 (JP) 2013-135361

(51) Int. Cl. H04L 29/08

(52) U.S. Cl. CPC H04L 67/10
USPC 709/219

(57) ABSTRACT

According to one embodiment, an individual information management system includes a first electronic device and a second electronic device. The second electronic device is distinct and apart from the first electronic device and communicably connected to the first electronic device. The first electronic device is configured to store individual information in the second electronic device. The individual information is associated with data acquired from a server connected to the first electronic device through a network.

### CROSS-REFERENCE TO RELATED APPLICATIONS

This application is based upon and claims the benefit of priority from Japanese Patent Application No. 2013-135361, filed Jun. 27, 2013, the entire contents of which are incorporated herein by reference.

### FIELD

An embodiment described herein relates generally to an individual information management system, an electronic device, and a method for managing individual information.

### BACKGROUND

Conventionally, there has been known a technology for acquiring data such as a web page from a server including a web server through a network. In such a technology, individual information such as a Cookie associated with the data of a web page or the like is stored in a device that has acquired the data from the server and is managed by the device.

In the above technology, as an example, it is desirable to be able to allow a device other than the device that has acquired the data from the server to store therein the individual information.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram illustrating an overall structure of a Cookie management system according to one embodiment;

FIG. 2 is an exemplary block diagram illustrating internal structure of a television device and a tablet in the embodiment;

FIG. 3 is an exemplary diagram illustrating a browser screen displayed on a display module of the television device in the embodiment;

FIG. 4 is an exemplary diagram illustrating a first screen displayed on a display module of the tablet in the embodiment;

FIG. 5 is an exemplary diagram illustrating a second screen displayed on the display module of the tablet in the embodiment;

FIG. 6 is an exemplary sequence diagram illustrating processing performed by the Cookie management system in the embodiment;

FIG. 7 is an exemplary flowchart illustrating processing performed on the television device side when the television device displays a web page, in the embodiment;

FIG. 8 is an exemplary flowchart illustrating processing performed on the tablet side when a Cookie is newly generated by and stored in the tablet, in the embodiment; and

FIG. 9 is an exemplary flowchart illustrating processing performed on the tablet side when a Cookie is transmitted from the tablet to the television device, in the embodiment.

### DETAILED DESCRIPTION

In general, according to one embodiment, an individual information management system comprises a first electronic device and a second electronic device. The second electronic device is distinct and apart from the first electronic device and communicably connected to the first electronic device. The first electronic device is configured to store individual information in the second electronic device. The individual information is associated with data acquired from a server connected to the first electronic device through a network.

The following describes an embodiment with reference to the drawings.

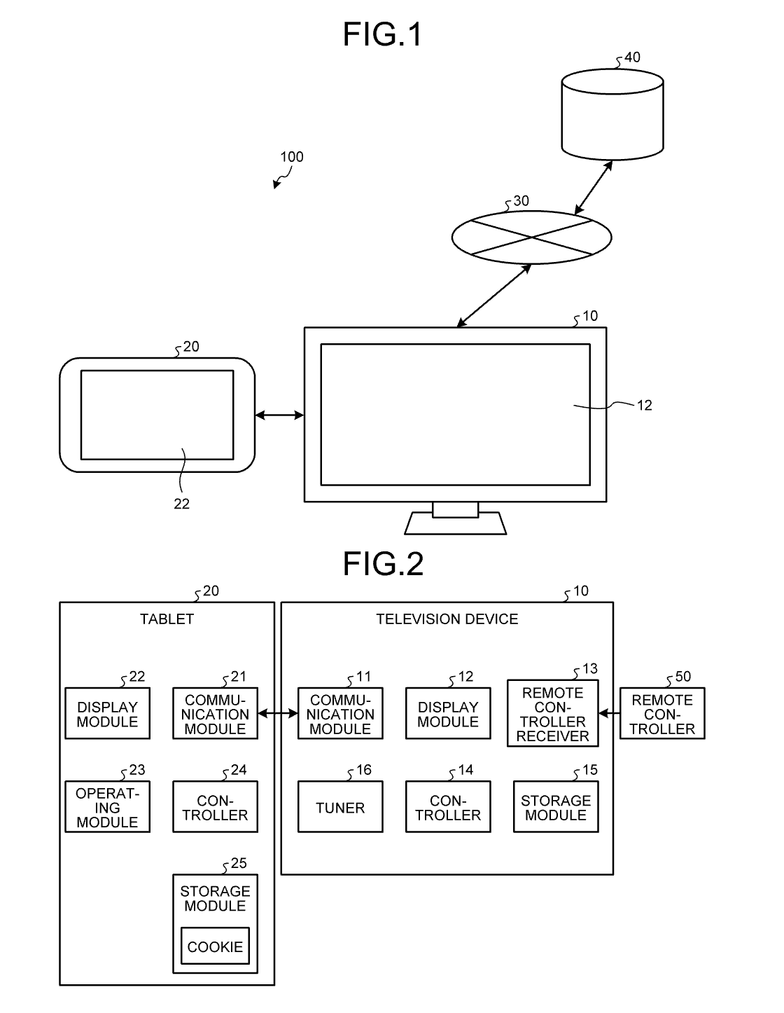

Described first with reference to FIG. 1 to FIG. 4 is an example of an overall structure of a Cookie management system according to the embodiment. The Cookie management system 100 is an example of an “individual information management system.”

As illustrated in FIG. 1, the Cookie management system 100 comprises a television device 10 and a tablet 20. The television device 10 is an example of an “electronic device” and an example of a “first electronic device.” The tablet 20 is an example of “another electronic device” and an example of a “second electronic device.”

The television device 10 is connected to a web server 40 through a network 30 such as the Internet. This web server 40 is configured to provide data including web content such as web pages through the network 30.

The television device 10 and the tablet 20 are communicably connected to each other. Specifically, the television device 10 is configured to perform, so that various kinds of data (for example, a Cookie described below) are transmitted to and received from the tablet 20, communications conforming to a wireless communication standard that requires no access point such as a router (for example, Wi-Fi Direct (registered trademark)).

As illustrated in FIG. 2, the television device 10 comprises a communication module 11, a display module 12, a remote controller receiver 13, a controller 14, a storage module 15, and a tuner 16. The tablet 20 comprises a communication module 21, a display module 22, an operating module 23, a controller 24, and a storage module 25.

The communication module 11 of the television device 10 is connected to the web server 40 (see FIG. 1) through the network 30. The communication module 11 is communicably connected to the communication module 21 of the tablet 20. The display module 12 of the television device 10 is configured to be capable of displaying video.

The remote controller receiver 13 of the television device 10 is configured to receive a remote controller signal transmitted from a remote controller 50 for operating the television device 10. The controller 14 of the television device 10 is configured to control each component of the television device 10. The storage module 15 of the television device 10 is provided in order to store therein various computer programs to be executed by the controller 14. The tuner 16 of the television device 10 is provided to receive a broadcast wave transmitted from a broadcasting station (not illustrated).

The communication module 21 of the tablet 20 is communicably connected to the communication module 11 of the television device 10. The display module 22 of the tablet 20 is configured to be capable of displaying video. The operating module 23 of the tablet 20 functions as input means for an operation on the tablet 20 by a user. The operating module 23 includes, for example, a touch panel using the display module 22.

The controller 24 of the tablet 20 is configured to control each component of the tablet 20. The storage module 25 of the tablet 20 is provided to store therein various computer programs to be executed by the controller 24 and various kinds of data to be used when the various programs are executed.

In the embodiment, the television device 10 has a browsing function that displays a web page acquired from the web server 40 and allows a user to browse it. Specifically, the television device 10 is configured to transmit a hypertext transfer protocol (HTTP) request to the web server 40 when there arises a web page browsing request from the user. The HTTP request is a request for transmitting data to display the web page. The data to display the web page is, for example, hypertext markup language (HTML) data. The web server 40 is configured to transmit (return) an HTTP response to the television device 10 upon receiving the HTTP request from the television device 10. The HTTP response includes the data of the web page designated by the HTTP request.

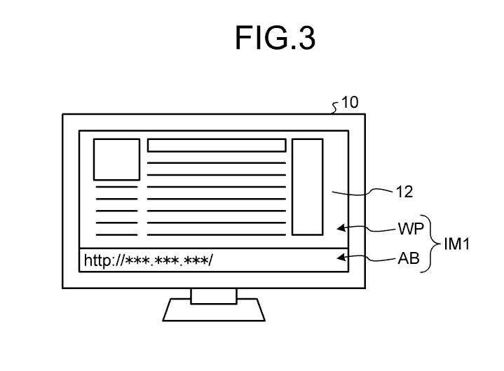

The television device 10 is configured to display, upon receiving the HTTP response from the web server 40, the web page on the display module 12 based on the data included in the HTTP response. In this case, the television device 10 is configured to display, for example, a browser screen IM1 illustrated in FIG. 3. The browser screen IM1 illustrated in FIG. 3 includes, as an example, a web page WP and an address bar AB. In the address bar AB, the universal resource locator (URL) of the web page WP is displayed.

The browsing request as described above is performed based on an operation on the remote controller 50 by the user (for example, an operation of inputting a URL to the address bar AB of the browser screen IM1 illustrated in FIG. 3) or the like.

In some cases such as when browsing the same web page two or more times and when browsing a web page related to a web page currently browsed, it is desirable to migrate a browsing environment including a web page display manner for each HTTP session (the exchange of an HTTP request and an HTTP response). Given this situation, in the HTTP session, a Cookie may be used as individual information for identifying a terminal (a user) that has exchanged an HTTP request and an HTTP response with the web server 40.

In this case, in the embodiment, the television device 10 is configured to store individual information (a Cookie), that is associated with data (data for displaying a web page) acquired from the web server 40, not in the storage module 15 of the television device 10 but in the storage module 25 of the tablet 20.

More specifically, the television device 10 in the embodiment is configured to transmit a request (first request) to the tablet 20 when acquiring the data of a web page (first data) from the web server 40. The first data is data not corresponding to a Cookie (first individual information) stored in the tablet 20 in the past. The first request is a request for newly generating and storing therein a Cookie (second individual information different from the first individual information) corresponding to the web page. Examples of the case of acquiring the data (the first data) not corresponding to the past Cookie (the first individual information) include a case of browsing a web page never browsed in the past. The tablet 20 is configured to generate and store therein a new Cookie (the second individual information) specified in the first request upon receiving the first request from the television device 10.

In the embodiment, when a web page never browsed in the past is browsed, an HTTP response transmitted from the web server 40 to the television device 10 includes a Set-Cookie header that specifies a new Cookie for use in the following accesses. The television device 10 is configured to transmit the first request to the tablet 20 upon receiving the HTTP response including the Set-Cookie header from the web server 40. The first request is a request for generating and storing therein a new Cookie specified by the Set-Cookie header. The tablet 20 is configured to generate and store the new Cookie specified by the Set-Cookie header in the storage module 25 upon receiving the first request from the television device 10.

In the embodiment, the television device 10 is configured to transmit a request (a second request) to the tablet 20 when acquiring the data of a web page (second data) from the web server 40. The second data is data corresponding to the Cookie (the first individual information) stored in the tablet 20 in the past. The second request is a request for transmitting the Cookie (the first individual information) corresponding to the web page. Examples of the case of acquiring the data (the second data) corresponding to the past Cookie (the first individual information) include a case of browsing in which a web page browsed once or more times in the past and a web page related to the web page (a web page sharing a common domain or the like). The tablet 20 is configured to read the past Cookie (the first individual information) specified in the second request from the storage module 25 upon receiving the second request from the television device 10 and to transmit it (the past Cookie) to the television device 10. Such a Cookie exchange may be encrypted by the television device 10.

The television device 10 is configured to transmit, when a web page browsed in the past or a web page related to the web page is browsed, an HTTP request with the Cookie received from the tablet 20 to the web server 40, so that an HTTP response corresponding to the Cookie is received from the web server 40. This allows the display module 12 of the television device 10 to display the browser screen IM1 including a web page with the past browsing environment migrated (see FIG. 3).

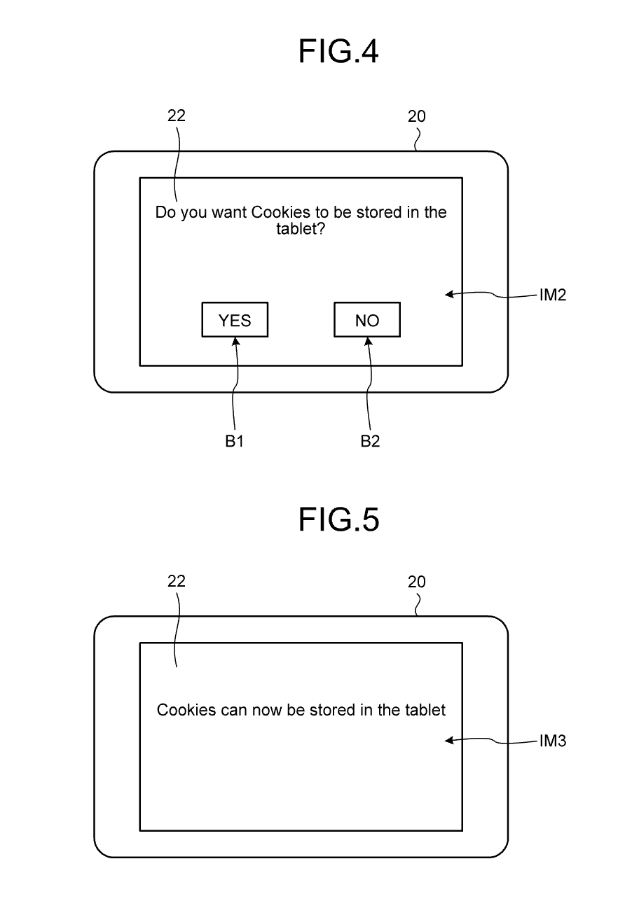

In the embodiment, such a Cookie management service as described above (a service to store a Cookie not in the television device 10 but in the tablet 20) is started based on an operation on the tablet 20 by a user. Specifically, the tablet 20 is configured to display a first screen IM2 illustrated in FIG. 4 on the display module 22, so that whether to store a Cookie in the tablet 20 is inquired of the user. The first screen IM2 includes a message “Do you want Cookies to be stored in the tablet?”, a “YES” button B1, and a “NO” button B2. The user can start the Cookie management service described above by pressing (touching) the “YES” button B1 displayed in the first screen IM2. The first screen IM2 is called up based on an operation on the operating module 23 of the tablet 20 by the user.

The tablet 20 is configured to make, when the operation of pressing the “YES” button B1 on the first screen IM2 (see FIG. 4) is performed by the user, an inquiry about whether there is any device (the television device 10 in the embodiment) that can transmit and receive a Cookie. The television device 10 is configured to inform (reply to), upon receiving the inquiry from the tablet 20, the tablet 20 that the television device 10 can transmit and receive a Cookie in response to the inquiry. Such an exchange, which is made between the tablet 20 and the television device 10, establishes communication (wireless communication conforming to Wi-Fi Direct (registered trademark)) between the tablet 20 and the television device 10.

As described above, the tablet 20 is configured to display a second screen IM3 illustrated in FIG. 5 on the display module 22 when communication between the tablet 20 and the television device 10 is established, so that the user is informed that the tablet 20 is ready to store therein Cookies. The second screen IM3 includes a message “Cookies can now be stored in the tablet”. Such a Cookie management service as described above stops when the communication between the tablet 20 and the television device 10 is cut off because the tablet 20 and the television device 10 become separated enough to impair the communication, for example.

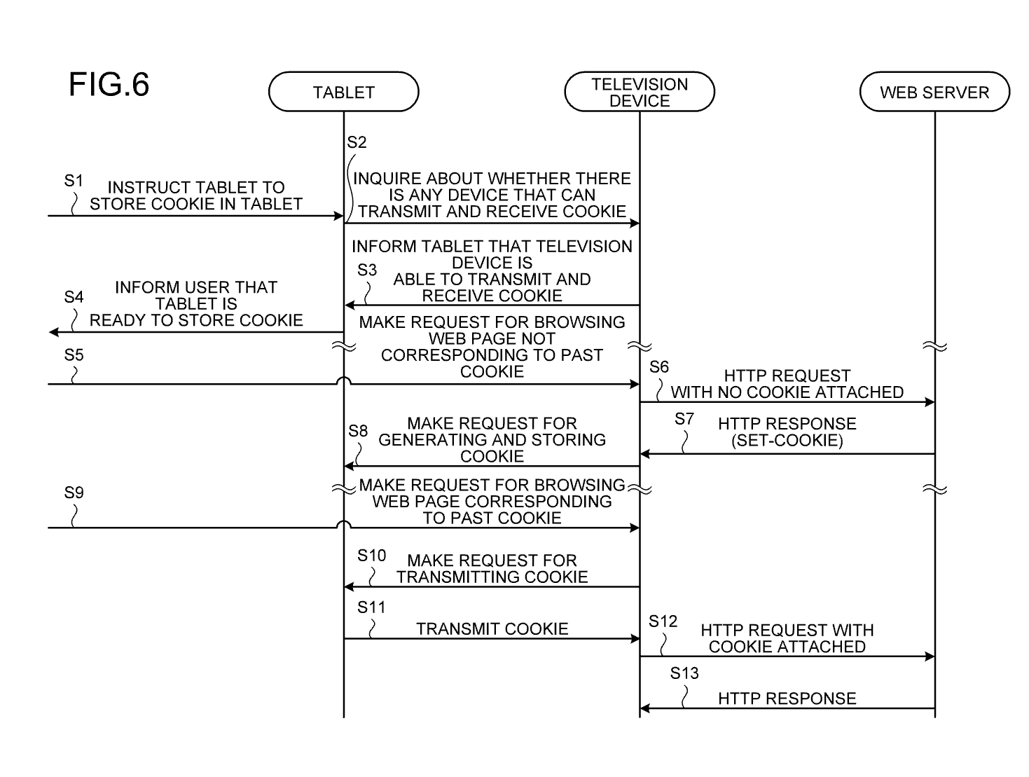

Described next schematically with reference to FIG. 6 is an example of the respective processing flows of the television device 10 and the tablet 20 in the Cookie management system 100 in the embodiment.

First, as illustrated in FIG. 6, assume that at S1 a user makes an instruction to store therein a Cookie to the tablet 20. Such an instruction is made by pressing the “YES” button B1 on the first screen IM2 as illustrated in FIG. 4.

When the instruction is made at S1, the tablet 20 makes an inquiry about whether there is any device (the television device 10 in the embodiment) that can transmit and receive the Cookie at S2. Upon receiving the inquiry, the television device 10 informs the tablet 20 that the television device 10 can transmit and receive the Cookie at S3.

As a result of processing of S2 and S3, communication (communication conforming to Wi-Fi Direct (registered trademark)) between the tablet 20 and the television device 10 is established. Then, at S4, the tablet 20 informs the user that the tablet 20 is ready to store therein the Cookie by displaying the second screen IM3 illustrated in FIG. 5 on the display module 22.

Described next is a case in which the user makes at S5 a web page browsing request, which is a request to the television device 10 for browsing a web page not corresponding to the Cookie stored in the tablet 20 in the past (for example, a web page never browsed in the past).

In this case, because the tablet 20 does not store therein a Cookie corresponding to the web page requested for browsing, the television device 10 transmits to the web server 40 an HTTP request with no Cookie attached at S6. At S7, the web server 40 transmits an HTTP response, which includes the content of the web page requested for browsing, to the television device 10 upon receiving the HTTP request from the television device 10.

The HTTP response at S7 includes a Set-Cookie header that specifies a new Cookie for use in the following accesses. Upon receiving the HTTP response including the Set-Cookie header from the web server 40, the television device 10 transmits at S8 a request (a first request), which is a request to newly generate and store therein the specified Cookie, to the tablet 20. At the same time, the television device 10 displays the web page included in the HTTP response on the browser screen IM1 (see FIG. 3).

Upon receiving the first request described above from the television device 10, the tablet 20 generates the Cookie specified in the first request and stores the Cookie in the storage module 25. The Cookie is stored in the storage module 25 in a state where associated with the URL or the like of the web page requested for browsing.

Described next is a case in which the user makes at S9 a web page browsing request, which is a request to the television device 10 for browsing a web page corresponding to the Cookie stored in the tablet 20 in the past (for example, a web page browsed in the past or a web page related to the web page).

In this case, because the tablet 20 stores therein the Cookie corresponding to the web page requested for browsing, the television device 10 transmits at S10 a request (a second request), which is a request to the tablet 20 for transmitting the Cookie corresponding to the web page requested for browsing to the television device 10.

Upon receiving the second request described above from the television device 10, the tablet 20 reads the Cookie specified in the second request from the storage module 25 and transmits the Cookie to the television device 10 at S11. Upon receiving the Cookie from the tablet 20, the television device 10 transmits an HTTP request with the received Cookie to the web server 40 at S12.

Upon receiving the HTTP request with the Cookie attached, the web server 40 transmits an HTTP response, which includes the content of the web page corresponding to the received Cookie, to the television device 10 at S13. Upon receiving the HTTP response from the web server 40, the television device 10 displays the web page included in the HTTP response on the browser screen IM1 (see FIG. 3).

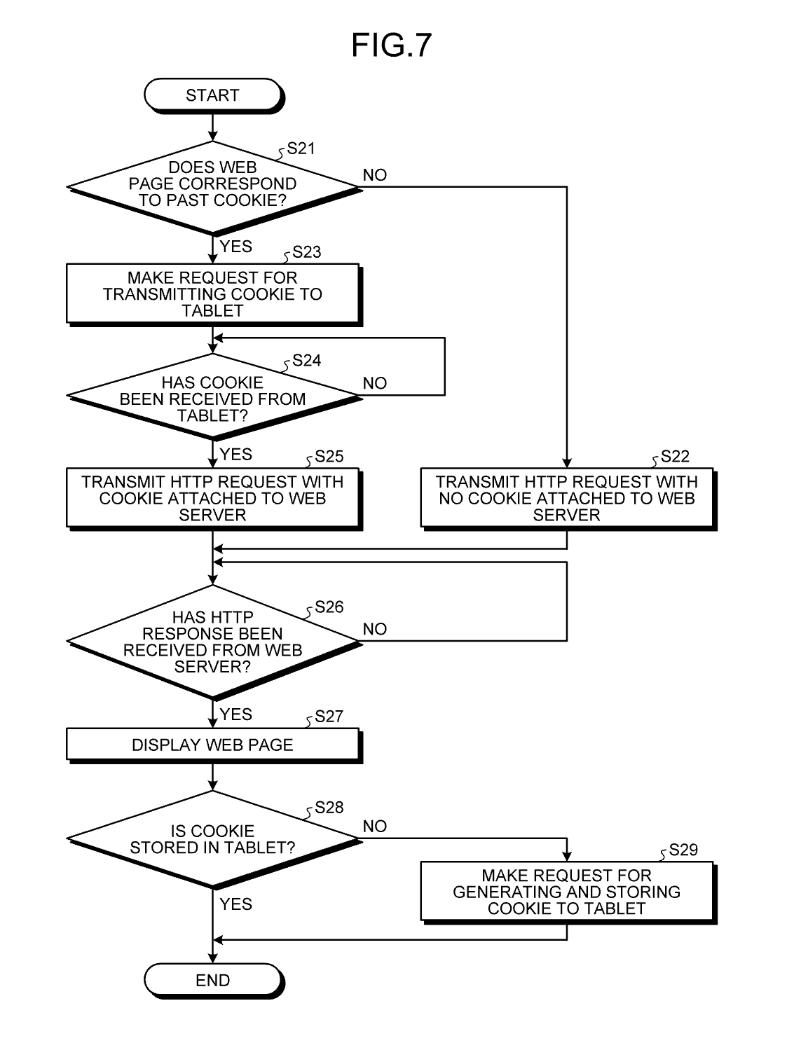

Described next with reference to FIG. 7 is an example of a processing flow performed on the television device 10 side when the television device 10 displays a web page, in the embodiment. This processing flow starts when, for example, the user performs an operation of requesting the browsing of a web page on the television device 10 using the remote controller 50 or the like.

In this processing flow, first at S21, processing is performed to determine whether the web page requested for browsing corresponds to the Cookie stored in the tablet 20 in the past (for example, whether the web page is a web page browsed in the past or a web page related to the web page).

At S21, if it is determined that the web page requested for browsing does not correspond to the past Cookie, the processing advances to S22. At S22, processing is performed to transmit an HTTP request with no Cookie attached to the web server 40, and then the processing advances to S26 described below.

In contrast, at S21, if it is determined that the web page requested for browsing corresponds to the past Cookie, the processing advances to S23. At S23, processing is performed to transmit a request (a second request), which is a request to the tablet 20 for transmitting the Cookie corresponding to the web page requested for browsing, and then the processing advances to S24.

At S24, processing is performed to determine whether the Cookie specified in the second request has been received from the tablet 20. This processing at S24 repeats until it is determined that the Cookie has been received. If it is determined that the Cookie has been received at S24, the processing advances to S25.

At S25, processing is performed to transmit an HTTP request with the Cookie received from the tablet 20 to the web server 40, and then the processing advances to S26.

At S26, processing is performed to determine whether an HTTP response corresponding to the HTTP request transmitted at S22 or S25 has been received from the web server 40. This processing at S26 repeats until it is determined that the HTTP response has been received. If it is determined that the HTTP response has been received at S26, the processing advances to S27.

At S27, processing is performed to display the web page included in the received HTTP response on the browser screen IM1 (see FIG. 3), and the processing advances to S28.

At S28, processing is performed to determine whether the tablet 20 stores therein the Cookie corresponding to the web page displayed at S27 (the web page currently displayed on the browser screen IM1 (see FIG. 3)).

At S28, if it is determined that the tablet 20 does not store therein the Cookie corresponding to the web page currently displayed (for example, when a web page never displayed in the past is currently displayed), the processing advances to S29. At S29, processing is performed to transmit a request (a first request), which is a request to the tablet 20 for newly generating and storing therein a Cookie corresponding to the web page currently displayed, and the processing ends.

In contrast, at S28, if it is determined that the tablet 20 already stores therein the Cookie corresponding to the web page currently displayed (for example, when a web page browsed in the past or a web page related to the web page is currently displayed), the processing of S29 is not performed, and the processing ends immediately.

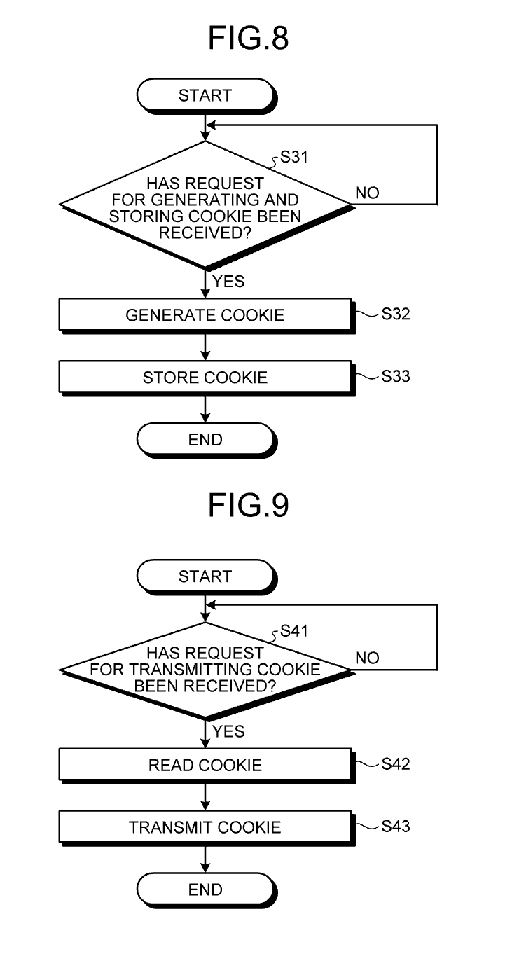

Described next with reference to FIG. 8 is an example of a processing flow performed on the tablet 20 side when the tablet 20 newly generates and stores therein a Cookie, in the embodiment. This processing flow starts when the television device 10 transmits to the tablet 20 a request (a first request) to newly generate and store therein a Cookie corresponding to a web page never browsed in the past (see S29 in FIG. 7), resulting from a request to the television device 10 for browsing the web page by the user's operation on the remote controller 50, for example.

In this processing flow, as illustrated in FIG. 8, first at S31, processing is performed to determine whether the request (the first request) for newly generating and storing a Cookie has been received from the television device 10. The processing at S31 repeats until it is determined that the first request has been received. If it is determined that the first request has been received at S31, the processing advances to S32.

Next at S32, processing is performed to generate the Cookie specified in the first request, and the processing advances to S33. At S33, processing is performed to store the generated Cookie in the storage module 25, and the processing ends.

Described next with reference to FIG. 9 is an example of a processing flow performed on the tablet 20 side when a Cookie is transmitted from the tablet 20 to the television device 10, in the embodiment. This processing flow starts when the television device 10 transmits to the tablet 20 a request (a second request) to transmit a Cookie corresponding to a web page browsed once or more times in the past (see S23 in FIG. 7), resulting from a request to the television device 10 for browsing the web page by the user's operation on the remote controller 50, for example.

In this processing flow, as illustrated in FIG. 9, first at S41, processing is performed to determine whether the request (the second request) for transmitting a Cookie has been received from the television device 10. The processing at S41 repeats until it is determined that the second request has been received. If it is determined that the second request has been received at S41, the processing advances to S42.

Next at S42, processing is performed to read the Cookie specified in the second request from the storage module 25, and the processing advances to S43. At S43, processing is performed to transmit the read Cookie to the television device 10, and the processing ends.

As described above, in the embodiment, the controller 14 of the television device 10 is configured to control to store the individual information (the Cookie) not in the storage module 15 of the television device 10 but in the storage module 25 of the tablet 20. The individual information (the Cookie) is associated with the data (the web page data) acquired from the web server 40 connected through the network 30. As a result of this, as an example, the Cookie can be stored and managed in a device (the tablet 20) other than the television device 10. This advantageous effect is particularly useful in some cases such as when one television device is shared by a plurality of users and when a web page browsing environment is migrated between two or more different television devices.

In the embodiment, as described above, the controller 14 of the television device 10 is configured to transit a request (first request) to the tablet 20 when acquiring from the web server 40 the data of a web page (first data) not corresponding to the Cookie (first individual information) stored in the tablet 20 in the past. The first request is a request to the tablet 20 for newly generating and storing therein a Cookie (second individual information different from the first individual information) corresponding to the web page. Examples of the case of acquiring the data (the first data) not corresponding to the past Cookie (the first individual information) include a case of browsing a web page never browsed in the past. The controller 24 of the tablet 20 is configured to generate and store a new Cookie (the second individual information) specified in the first request in the storage module 25 when the first request is received from the television device 10. As a result of this, as an example, the Cookie can be easily stored and managed in a device (the tablet 20) other than the television device 10.

In the embodiment, as described above, the controller 14 of the television device 10 is configured to transmit a request (the second request) to the tablet 20 when acquiring from the web server 40 the data of a web page (second data) corresponding to the Cookie (the first individual information) stored in the tablet 20 in the past. The second request is a request to the television device 10 for transmitting the Cookie (the first individual information) corresponding to the web page. Examples of the case of acquiring the data (the second data) corresponding to the past Cookie (the first individual information) include a case of browsing a web page browsed once or more times in the past and a web page related to the web page (a web page sharing a common domain or the like). The controller 24 of the tablet 20 is configured to read the past Cookie (the first individual information) specified in the second request from the storage module 25 and transmit the past Cookie to the television device 10, when the second request is received from the television device 10. As a result of this, as an example, the tablet 20 can transmit a necessary Cookie to the television device when necessary.

In the embodiment, as described above, the controller 14 of the television device 10 is configured to transmit to the web server 40 the Cookie (the first individual information) received from the tablet 20, so that the HTTP response (the second data corresponding to the first individual information) is acquired from the server 40. The HTTP response includes HTML data for displaying a web page corresponding to the Cookie or the like. As a result of this, as an example, the HTML data for displaying the web page corresponding to the Cookie or the like can be easily acquired from the web server 40.

In the embodiment, as described above, the tablet 20 is configured to make an inquiry about whether the television device 10 as the source of the Cookie (the individual information) exists and the television device 10 is configured to make a response to the inquiry, so that communication (wireless communication conforming to Wi-Fi Direct (registered trademark)) between the television device 10 and the tablet 20 is established. As a result of this, as an example, concurrently with the establishment of the communication between the television device 10 and the tablet 20, the Cookie can be stored and managed in a device (the tablet 20) other than the television device 10.

For example, the above embodiment shows an example of a technology that a television device is used as an “electronic device (a first electronic device)”. However, the technology may include a technology that a device other than a television apparatus (for example, a recording device that outputs video to a television device or a video device such as a set-top box) is used as an “electronic device (a first electronic device)”.

The above embodiment shows an example of a technology that a tablet (a portable information terminal) is used as “another electronic device (the second electronic device)”. However, the technology may include a technology that a portable information terminal other than a tablet (for example, a smartphone) is used as “another electronic device (the second electronic device)”, and a technology that a device other than portable information terminal (for example, a personal computer (PC)) is used as “another electronic device (the second electronic device)”.

The above embodiment shows an example of a technology that a Cookie is used as individual information exchanged with a web server. However, the technology may include a technology that information other than a Cookie is used as individual information. The above embodiment shows an example of a technology that wireless communication conforming to Wi-Fi Direct (registered trademark) is performed between a television device and a tablet. However, the technology may include a technology that communication conforming to any communication standard other than Wi-Fi Direct (registered trademark) is performed between the television device and the tablet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An individual information management system comprising:
a first electronic device and a second electronic device that is distinct and apart from the first electronic device and communicably connected to the first electronic device, wherein
the first electronic device is configured to store individual information in the second electronic device, the individual information being associated with data acquired from a server connected to the first electronic device through a network.

2. The individual information management system of claim 1, wherein the first electronic device is not configured to store the individual information in the first electronic device.

3. The individual information management system of claim 1, wherein
the first electronic device is configured to make a first request to the second electronic device when acquiring first data from the server, the first data being data not corresponding to first individual information stored in the second electronic device in the past, the first request being a request for newly generating and storing therein second individual information different from the first individual information, and
the second electronic device is configured to newly generate and store therein the second individual information when the first electronic device makes the first request.

4. The individual information management system of claim 3, wherein
the first electronic device is configured to make a second request to the second electronic device when acquiring second data from the server, the second data being data corresponding to the first individual information, the second request being a request to the first electronic device for transmitting the first individual information, and
the second electronic device is configured to transmit the first individual information to the first electronic device when the first electronic device makes the second request.

5. The individual information management system of claim 4, wherein the first electronic device is configured to transmit the first individual information received from the second electronic device to the server, so that the second data is acquired from the server.

6. The individual information management system of claim 1, wherein the second electronic device is configured to make an inquiry about whether the first electronic device as the source of the individual information exists and the first electronic device is configured to make a response to the inquiry, so that communication between the first electronic device and the second electronic device is established.

7. An electronic device communicably connected to another electronic device that is distinct and apart from the electronic device, the electronic device comprising:
a controller configured to perform a control to store individual information in the other electronic device, the individual information being associated with data acquired from a server connected to the electronic device through a network.

8. The electronic device of claim 1, wherein the controller is not configured to perform a control to store the individual information in the electronic device.

9. A method for managing individual information using a first electronic device and a second electronic device that is distinct and apart from the first electronic device and communicably connected to the first electronic device, the method comprising:
storing individual information in the second electronic device, the individual information being associated with data acquired from a server connected to the first electronic device through a network.

10. The method of claim 9, wherein the first electronic device is not configured to store the individual information in the first electronic device.
